(19) United States
(12) Patent Application Publication
(10) Pub. No.: US 2012/0086349 A1
(43) Pub. Date: Apr. 12, 2012

(54) Decorative Light System

(75) Inventor: Marc H. SEGAN, New York, NY (US)

(73) Assignee: Segan LLC, Mount Kisco, NY (US)

(21) Appl. No.: 13/267,568

(22) Filed: Oct. 6, 2011

Related U.S. Application Data
(60) Provisional application No. 61/390,381, filed on Oct. 6, 2010.

(51) Int. Cl. H05B 37/02

(52) U.S. Cl. 315/187; 315/185 R; 315/193

(57) ABSTRACT

A light string includes a plurality of remote units and a control unit. Each of the plurality of remote units includes a microcontroller and is connected to a plurality of lights. Each microcontroller stores one or more programs for controlling the lights in the plurality of lights. The control unit is connected to the plurality of remote units by a power supply line. The control unit sends information via the power supply line to the plurality of remote units. The information indicates a program of the one or more programs to be executed by the microcontroller of each of the remote units to individually control the plurality of lights.

### RELATED APPLICATIONS

This application claims priority from U.S. Provisional Patent Application Ser. No. 61/390,381 which was filed on Oct. 6, 2010.

### FIELD OF THE INVENTION

The present invention relates to a light string and in particular to a light string having individual lights that can be activated under independent control.

### DESCRIPTION OF THE RELATED ART

Originally created as a safer alternative to real candles on Christmas trees, electric Christmas lights have been manufactured and sold for nearly 100 years. Small wattage line-voltage (120V AC) bulbs, wired in parallel, were originally the only type offered. The 1970's brought so-called mini-lights, low-wattage, low-voltage bulbs wired in series. These lights generated much less heat and are much smaller and less expensive than line-voltage bulbs. Over the years, mini-lights have become extremely inexpensive, almost to the point of the cost of the commodities involved—copper, plastic, glass—as their manufacture and sale ballooned. Indeed, strings of mini-lights have become virtually consumable.

To add value through product differentiation, manufacturers added various effects such as twinkling and sequencing. As integrated circuits and especially one-chip microcontrollers fell in price, various blinking, dimming, chasing, and sequencing devices became practical and popular. Generally, these were made for use with mini-lights.

The advent of Light Emitting Diodes (LEDs) promised advances in holiday lighting. The relative permanence, extremely long life, and low power consumption of LEDs were attractive features from the start. More recently, technical developments have allowed LEDs to come into their own and market trends have cooperated in highlighting their advantages. Now LEDs come in many different colors, with far better brightness and much more affordable prices. With the higher cost of energy along with a generally heightened consumer and retailer sensitivity to environmental concerns, both energy efficiency and avoiding disposability makes LEDs more common and attractive for holiday lighting applications.

In fact, the unique characteristics of LEDs lead to new product possibilities. LEDs are inherently diodes, which means that they conduct current in only one direction. This creates new circuit opportunities and potential design efficiencies. LEDs are also extremely energy efficient, consuming very little current and producing very little heat. This allows LEDs to be driven with different kinds of circuits, potentially directly by the ordinary output ports of integrated circuits. The semiconductor, as opposed to incandescent, nature of LEDs means that they can be switched on and off with far greater rapidity than bulbs. This leads to possibilities for multiplexing to control brightness and color. Finally, LEDs practically never burn out. Therefore, a product employing LEDs can support somewhat more elaborate surrounding circuitry, since added cost will not be wasted on a product expected to be discarded after a single season.

The decrease in the cost of integrated circuits has allowed microcontrollers to be used to control light strings to create various lighting effects. U.S. Pat. No. 6,946,805 discloses a controller for controlling decorative light displays that includes a plurality of outlet ports for providing power to a plurality of decorative light strings. However, the controller must send a full pattern to each of the output ports for controlling each of the plurality of decorative light strings each of which requires individual addressing from the controller.

Furthermore, in a conventional constant-on series light string of 2 volt LEDs powered by an AC wall power supply, no more than 50 or so LEDs can be wired in series before running out of available line voltage.

Digitally controlled light strings may require an excess of wire conductor and other components at a time when the price of copper conductor is both high and unpredictable. Moreover, thick wire harnesses are unwieldy and unsightly.

Conventionally, a master DC power supply (either transformer or switching-type supply) is required to operate the electronics for a digitally controlled LED light string system. DC power supplies are relatively expensive and, while they have some advantages, also introduce the need to consider wire resistance, because all LED currents must be added together. Moreover, such DC powered light strings are not easily extendible to operate additional downstream light strings either for purposes of power or synchronization.

### SUMMARY OF THE INVENTION

One objective of the present invention is to create a decorative (or holiday or similar) light string having individual lights that can be activated under completely independent control, thereby permitting any pattern of illumination. There are many practical constraints to achieving such a system, among them, cost of materials, ease and familiarity of manufacture, regulatory and safety compliance, and user-friendliness (including minimizing bulk of wiring). Example embodiments achieve this objective and others by distributing a plurality of microprocessor control circuits along a familiar light string with each disguised as a familiar replaceable bulb base and socket. Each microprocessor control circuit or remote unit contains program data to control adjacent lights under its immediate control and, instead of explicit instructions to each unit or light, requires only global control, time synchronization and user instructions. The few data bits required for such control are delivered through a subtle manipulation of the power waveform. The power supply may be a unique “stacking” of the low-voltage remote units that matches the voltage of the light string system to an AC plug supply and thus avoids the need for a transformer. A control unit coordinates the actions of the remote units and permits user control. However, a control unit is not necessarily required, and a light string according to an example embodiment may include remote units that initialize and synchronize upon receiving the AC waveform. The light string requires only two wires to power and control all of the remote units and allows various physical arrangements of the lights including “icicle” and straight-line sets.

An analogy may be drawn to an orchestra: the conductor (control unit) dictates time and instructs the many instrumentalists (remote units), each of which has his own sheet music (local microcontroller program data) in front of him to play his instrument (local plurality of lights).

Example embodiments thus provide for distributed intelligence, distributed programming, distributed power supply including quadruple use of an AC line frequency and distributed assembly. These various elements work together to optimize cost, ease of assembly and function of an integrated product including a light string according to example embodiments.

According to an example embodiment, a light string includes a plurality of remote units and a control unit. Each of the plurality of remote units includes a microcontroller and is connected to a plurality of lights. Each microcontroller contains one or more programs for controlling the lights in the plurality of lights. The control unit is connected to the plurality of remote units by a power supply line. The control unit sends information via the power supply line to the plurality of remote units. The information indicates a program of the one or more programs to be executed by the microcontroller of each of the remote units to individually control the plurality of lights.

According to an example embodiment, each microcontroller is connected to a different plurality of lights, and the one or more programs stored by each microcontroller is for individually controlling the different plurality of lights in synchronization with the other pluralities of lights.

According to an example embodiment, at least one light of the different plurality of lights connected to each of the remote units is integrated with the remote unit, and each of the remainder of the different plurality of lights connected to each of the remote units is external to the remote unit and connected to the remote unit by at least one LED control line.

According to an example embodiment, the plurality of remote units are in electrical series on the power supply line.

According to an example embodiment, the power supply line is configured to provide an AC waveform.

According to an example embodiment, the one or more programs stored by the microcontroller of each remote unit is a plurality of programs.

According to an example embodiment, the control unit comprises a semiconductor switching device configured to control one or both of the two phases of the AC waveform on the power supply line.

According to an example embodiment, the control unit is configured to send the information via the power supply line to the plurality of remote units by manipulating the AC waveform.

According to an example embodiment, the light string may further comprise a power outlet connected to the power supply line. The power outlet is configured to provide the AC waveform to another light string. A control unit of the other light string is configured to monitor the AC waveform and control another plurality of remote units based on the same information.

According to another example embodiment, a light string comprises a plurality of remote units and a power supply linea Each of the plurality of remote units comprises a microcontroller and is connected to a plurality of lights. Each microcontroller is configured to store one or more programs for controlling the lights in the plurality of lights. The power supply line is configured to provide an AC waveform to the plurality of remote units. The microcontrollers of each of the remote units are configured to initiate execution of the one or more programs to individually control the plurality of lights in response to the plurality of remote units receiving the AC waveform via the power supply line.

According to still another example embodiment, a light string comprises a plurality of remote units and a control unit. Each of the plurality of remote units comprises a microcontroller and is connected to a different single light. Each microcontroller is configured to store one or more programs for controlling the single light. The single light is integrated with the remote unit. The control unit is connected to the plurality of remote units by a power supply line and sends information via the power supply line to the plurality of remote units. The information indicates a program of the one or more programs to be executed by the microcontroller of each of the remote units to control the single light.

### BRIEF DESCRIPTION OF THE DRAWINGS

The invention will now be described in further detail with reference to the drawings in which:

FIG. 1A is a wiring diagram showing a light string according to an example embodiment;

FIG. 1B is a wiring diagram showing a light string according to another example embodiment;

FIG. 1C is a wiring diagram showing a light string according to still another example embodiment.

FIG. 2 is a schematic showing an example of a structure of a remote unit including an integrated LED;

FIG. 3A is schematic of a remote unit of a light string according to an example embodiment;

FIG. 3B is a schematic of a remote unit of a light string according to another example embodiment;

FIG. 3C is a schematic of a remote unit of a light string according to still another example embodiment.

FIG. 4 is a schematic of a control unit of a light string according to an example embodiment.

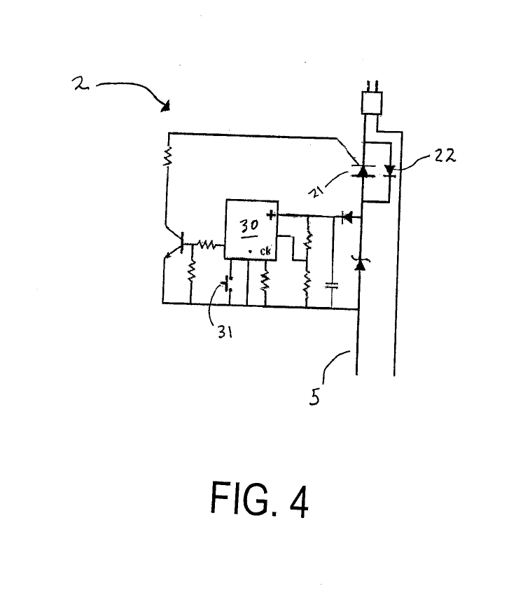

### DETAILED DESCRIPTION OF THE PRESENTLY PREFERRED EMBODIMENTS

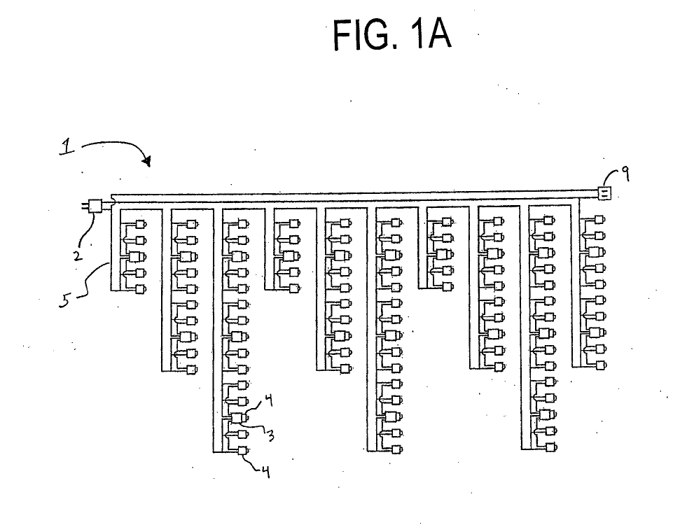

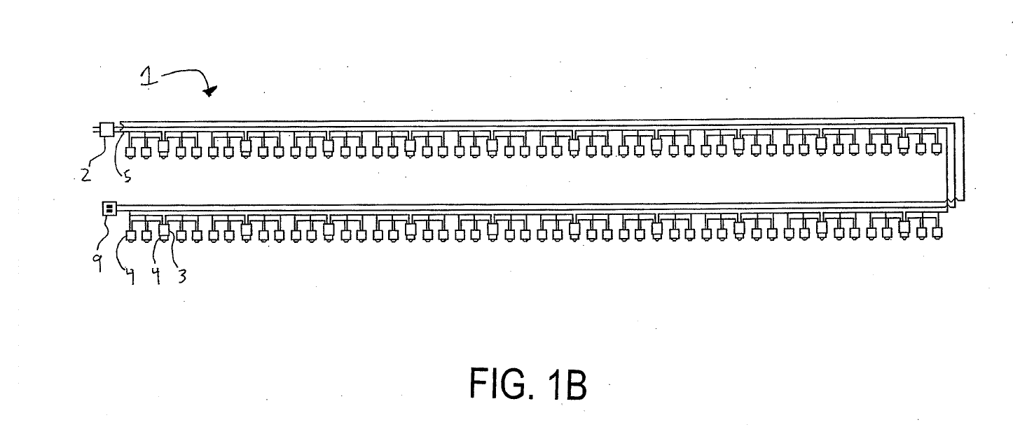

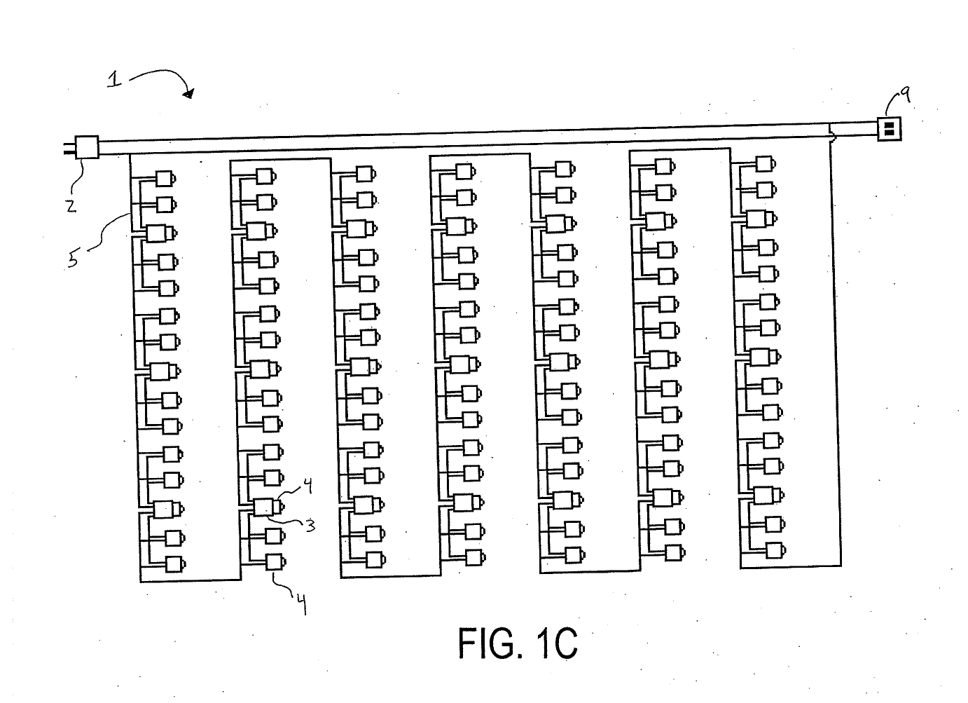

Example embodiments are directed to a decorative light string capable of independent control of each individual light. As shown in FIGS. 1A, 1B and 1C, a light string or system 1 according to an example embodiment includes a control unit 2, a plurality of remote units 3 and a plurality of lights 4. The lights 4 are preferably light emitting diodes (LEDs). Each remote unit 3 is configured to drive one or more “wing” lights 4 outboard of the remote unit 3 itself. The remote units 3 themselves physically include one or more of the lights 4. For example, the remote units 3 are integrated with one or more of the lights 4 and are physically nearly indistinguishable from the “wing” lights 4, thereby rendering the remote units 3 substantially camouflaged to a user so that the overall light string 1 appears nearly identical to a conventional standard light string. The light string 1 is preferably house-current AC-operated and employs preexisting parts from commonly available UL-approved constructions and other similar constructions.

The single control module 2 conveys a small amount of coordination information or data to the remote units 3, advising the remote units 3 of little more than which show is to be displayed and when to start the program for displaying the show. A light program, which when executed by the microcontroller 10 causes it to perform a show by controlling the lights 4 that causes the lights 4 to turn on and off in a predetermined or desired manner. That is, a “show” includes a group of sequentially arranged patterns for the lights 4 which are applied to the lights 4 simultaneously when the program is executed.

The following is a listing, by way of non-limiting example, of various example shows which may be used. A prototypical show of which the light string 1 is capable of displaying includes the illumination of a single light moving along the length of the light string 1 as shown in FIG. 1B. Without the capability of individual control of every single light as provided for by example embodiments, this behavior would be impossible. Another show for the same light string in FIG. 1B would be a ‘thermometer’ or ‘VU meter’ effect, in which a light at one end illuminates and is sequentially joined by adjacent lights until the entire string is illuminated. For a light string having an arrangement as shown in FIG. 1A, commonly referred to as an “icicle light”, an entertaining show may be a cascade, in which each individual “icicle” in the string displays illuminated lights “cascading” downward in chase patterns, at the same or different rates of speed. The illumination can be in groups of icicles or by individual icicle, but taken together produce the pleasing visual effect of a waterfall or falling rain or snow. An alternative to the above cascade show would be the exact reverse, a “falling” upward pattern. For the light string arrangement shown in FIG. 1C, a unique and entertaining show would be a diagonal chase pattern, in which the diagonal lines of lights move downward or upward rightward or leftward, accelerating or decelerating. Another show for the above arrangement of lights as shown in FIG. 1C would be a “filling” action, in which a single light illuminates and then, joined by other lights, “grows” outward, finally to illuminate the entire network. Additional patterns and shows can be easily imagined and created, limited only by the creativity of their composer because example embodiments are capable of illuminating any individual light at any time. To facilitate the composition of such lights shows, editing and data conversation software permits the composer to enter, test and edit shows on a computer screen, and then later to convert the data into the form required for the remote microcontrollers 10 in the remote units 3 and/or the control unit 2.

An example embodiment of the light string 1 allows for efficient manufacturing in that the components of the light string can be produced among two diverse types of factories, for example, the electronic system of the remote units 3 can be formed into a small structure that appears highly similar, if not identical to, a standard press-in LED bulb and base. First, it separates the electronics of the remote units 3 from the light string assembly, which call for highly dissimilar and somewhat incompatible types of manufacturing, allowing each type of factory to undertake only its accustomed function.

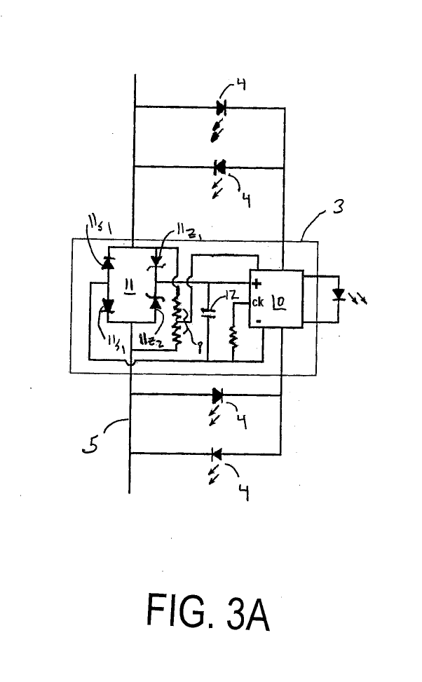

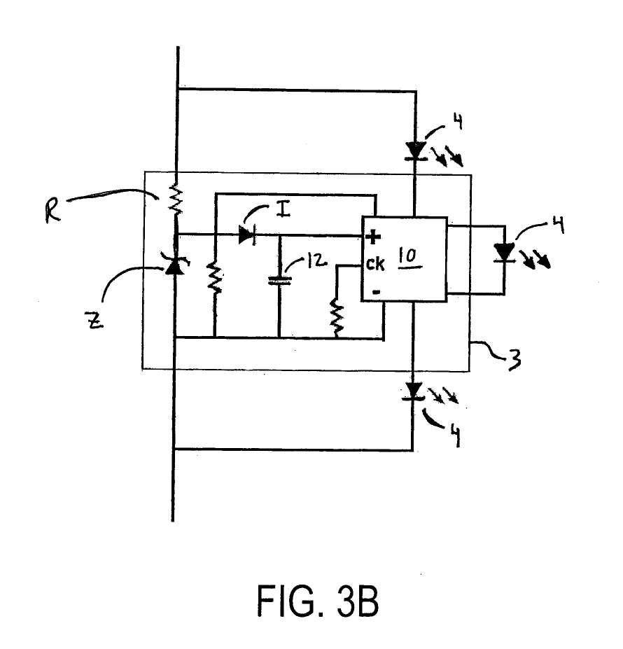

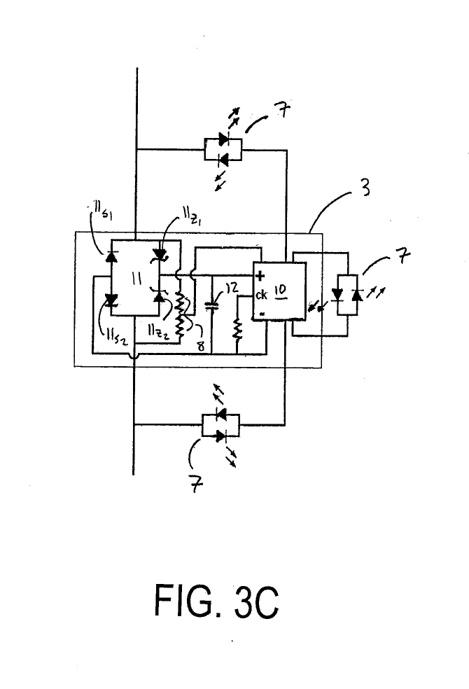

FIG. 3A is a schematic of a remote unit 3 of a light string according to an example embodiment. Each of the remote units 3 contains a microcontroller 10, one or more diodes, one or more resistors and a capacitor 12. The microcontroller 10 is preferably a very inexpensive microcontroller and includes a microprocessor and a program memory. The use of multiple microcontrollers distributed in the plurality of remote units 3, with each microcontroller 10 controlling five lights 4 (i.e., one light integrated with the remote unit 3, and four “wing” lights 4) provides a nearly optimally efficient use of wires and other parts, as well as the electrical environment. Alternatively, the necessary electronics may be deployed adjacent to each individual LED (i.e., a remote unit 3 integrated with each light 4) as in another example embodiment, and pre-programmed sequence memory for each individual LED driving remote unit 3 may be used in such a single-light-per-remote-unit system.

An example embodiment of the light string 1 includes remote unit 3 implemented as a plug-replaceable remote unit. i.e. it is replaceable by pressing into a socket similar to a standard UL-approved bulb socket. The structure of the plug-replaceable remote unit 3 provides for simple and easy debugging, for example, if a remote unit 3 proves defective or is incorrectly inserted, it is easily removed and replaced without a need to rework the light string 1.

One disadvantage of such plug-replaceable units is that the electro-mechanical accommodations required to bring about the replacement capability may compromise other desired features of the unit. For example, the unit itself and the socket each need separate and adequate plastic wall thicknesses, which results in a larger overall assembly. Moreover, the space and materials for electrical contacts not only add further to an overall size but can also result in lower reliability due to failed electrical connections. Accordingly, a single-light-per-remote-unit system using plug-replaceable remote units may present various disadvantages. A contact failure in the single remote unit will affect the multiple lights connected to the single remote unit and possibly the entire string.

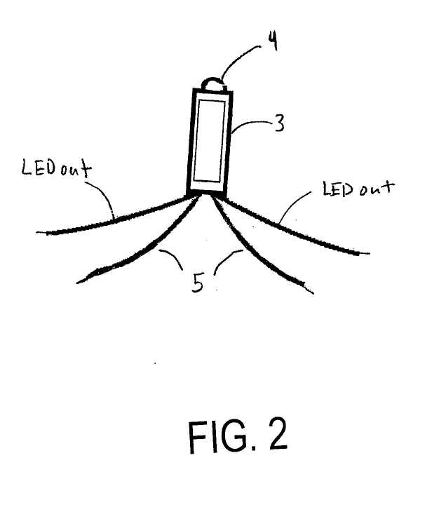

Another example embodiment is disclosed, which preserves the independent manufacture of the remote units 3. The remote units 3 may be manufactured in one-piece, with integrated lights 4, mechanically sealed, with measured lengths of connecting wires emerging from each. FIG. 2 is a schematic showing an example of a structure of a remote unit 3 manufactured in one piece and including an integrated LED. The structure is easily integrated with the rest of the light string 1 at the time of assembly. The size can be smaller and reliability enhanced as all internal components and external connections are hard-wired into place. The problems of wall thickness and potential contact failures are thus resolved.

Another advantage of example embodiments is the minimization of wire conductor and other components, especially at a time when the price of copper conductor is both high and unpredictable. Minimizing wires also delivers user benefits beyond low cost, since thick wire harnesses are unwieldy and unsightly. Moreover, for reasons of size, limiting the number of external electrical connections to the base of the remote module to only four helps to maintain a familiar “mini-light” socket form factor and also simplifies assembly.

Referring again to FIG. 1A, the plurality of remote units 3 are wired in electrical series on a power supply line 5, which enters and exits each remote unit 3. The power supply line 5 is connected to an AC power supply and provides an AC waveform. Only two other wires need exit each remote unit 3, one to each side of each remote unit 3, with each of the remaining two wires controlling one or two lights 4. Therefore, a total number of electrical contacts for each remote 3 is four: LED Left out, LED Right out, Power in, Power out. In a preferred embodiment, each LED wire controls two “wing” lights 4 and at least one light 4 integrated with and embedded in the remote unit 3 itself, configured to look like one of the “wing” lights. A “return” of the power supply line extends from the control unit 2 to a far end of the light string 1. Thus, between each remote unit 3 and the next there are only two wires: power and return. Between each remote unit 3 and its associated wing lights 4 there are a total of three wires: power, return and a local LED control line (LED Left out or LED Right out). If an “end-connect” feature (described in more detail below) is desired, an additional wire alongside the return line is required.

The microcontrollers 10 are pre-programmable and may be divided into groups in order to achieve an optimum balance between low cost and complexity of inventory. Each remote unit 3 may have a particular type of microcontroller 10 because each remote unit 3 may contain only its own local sequence programs. In a light string or system having one hundred LEDs in which each remote unit 3 controls five LEDs, there are in total twenty remote units 3. There may be five different microcontroller program “masks”, or built-in programs, all identical except for which set of LEDs they are intended to control. Each one of the five types of microcontrollers, which are manufactured as IC's, contains all the program information for four different positions along the light string, and each assumes the correct identity among those four positions by means of two inputs that are “pin-selected” at the time of manufacture. The programs are divided in this fashion so that each IC does not need to contain all program data for all remote units, but only for four types, thus saving the cost of an IC with a larger memory.

The microcontroller 10 of each remote unit 3 could easily contain all programs for all remote units in the same style light string, but at present this would be cost prohibitive and also require more pin-selection connections to identify the IC. On the other hand, twenty different program masks, each serving just one style of remote unit, could be employed if the resulting savings in memory justified that step, although the resulting complication of purchasing and inventory control must be considered in the overall cost. However, the price of field-programmable microcontrollers is constantly falling and ultimately such devices will become economical enough to allow exactly such 20 separate program mask to be implemented without the purchasing and inventory complications and without the need for I/O pin identification. Each of the resulting remote units 3 is visually marked to identify its type so as to simplify manufacturing and assembly. Each remote unit 3 can also be configured to identify itself during final assembly by flashing its lights appropriately when presented with a test condition.

At the time of manufacture, the remote units 3 are delivered to a light string assembler, who simply inserts the numbered remote units 3, e.g., one through twenty, into the correct sockets in the light string 1 or, if using the hard-wired type of module described above, simply wires the appropriate module into place in the string. If one of the remote units 3 fails to work properly or is incorrectly inserted, it may be easily replaced.

Example embodiments obviate the need for a master DC power supply (either transformer or switching type supply) that might otherwise be required to operate the electronics for a digital system. DC power supplies are relatively expensive and, while they have some advantages, they also introduce the need to consider wire resistance and, therefore, wire gauge, because all LED currents must be added together. Example embodiments avoid that complication and further, make use of the AC power supply signal in other ways.

A “wall-current” AC power supply is applied directly to the light string 1 on the power supply line 5 and a distributed power supply is implemented involving a “stack” of zener diodes in the remote units 3 to divide down the high voltage home AC supply among the remote units 3. That is, the power supplies of each the remote units 3 are wired in electrical series. As shown in FIG. 3A, each remote unit 3 includes a bridge rectifier system 11 and a hold-up capacitor 12 configured to create a local DC power supply from the AC waveform on the power supply line 5. In a preferred embodiment, the local rectifier system 11 is an asymmetrical bridge rectifier containing two zener diodes 11_{Z1}, 11_{Z2}, each having a voltage rating configured to be compatible with the local remote unit 3 IC, i.e., the microcontroller 10, and the LEDs 4 corresponding to that remote unit 3 (probably 5 volts), and two standard silicon diodes 11_{S1}, 11_{S2} configured to serve an isolation function. The two zener diodes 11_{Z1}, 11_{Z2} are rated at about 1 watt if the two zener diodes 11_{Z1}, 11_{Z2} conduct a maximum series current of the light string 1 of approximately 200 mA, (i.e., 200 mA×5 volts=1 Watt, which allows for a significant margin of safety because each zener diode is dissipating power for only half of the AC waveform). The other two standard silicon diodes 11_{S1}, 11_{S2} of the bridge 11 may be rated at a much lower power because their voltage drop is only about the 0.6V-0.7V of a standard silicon diode for the series current of the light string 1 of approximately 200 mA. The total voltage of the stack of zener diodes, i.e., the total voltage drop across the zener diodes 11_{Z1}, 11_{Z2} from each of the remote units 3, requires a margin of voltage somewhat below the peak of the AC wall-current power supply, so that the stack of zener diodes in the remote units 3 behaves as a single high voltage zener diode, conducting current when the peak of AC waveform voltage on the power supply line 5 exceeds a total rated voltage of the zener diode stack.

In an example embodiment including the bridge rectifier 11 as discussed above, there are effectively two stacks of diodes back-to-back, each conducting on alternate half-cycles of the AC power. In another example embodiment, a single zener diode Z and a single isolation diode I can be employed for each remote unit 3, as shown in FIG. 3B. However, a remote unit 3 configured with the single zener diode and the single isolation diode may drive only three LEDs 4. In still another example embodiment, a portion of remote units 3 that comprise the stack of zener diodes can have zener diodes oriented in one current direction and the other portion of the remote units 3 can have zener diodes oriented in the opposite current direction to take better advantage of the available voltage. In either the bridge rectifier or single-zener diode systems described above, when the AC supply voltage rises above the total rated voltage of the zener diode stack in the remote units 3, the resistive characteristic of the zener diodes absorbs the additional voltage and the local DC supply voltage at each remote unit 3 rises proportionally. Alternatively, either local low value resistors at each remote unit 3 and/or a single dropping resistor may be included to absorb the overvoltage, as shown in FIGS. 3A and 3B.

The AC waveform provided on the power supply line 5 is applied to the control unit 2, which comprises a semiconductor switching device 21 configured to control one or both of the two phases of the AC waveform for purposes of system control. For example, the semiconductor switching device 21 may comprise a silicon controlled rectifier (SCR) configured to control one of the two AC phases of the AC waveform as described below. A diode 22 in the control unit 2 conducts current on the alternate phase of the AC power supply signal. In another example embodiment, the semiconductor switching device 21 may comprise a triode for alternating current (TRIAC) configured to control the power and permitting control of both phases of the AC waveform. However, there are a several advantages to example embodiments that employ a control unit 2 that comprises a SCR. The SCR is less expensive, requires fewer components for operation, and is electrically more stable and less sensitive than a TRIAC. The SCR based control unit limits information or control instruction transmission frequency to 60 Hz, because only every other half-cycle of the AC waveform is available for control. This restriction on sending information or control instructions, however, is immaterial, because the need for control data may be only occasional and the number of bits very low due to the distributed intelligence and program features of example embodiments. In still another example embodiment, the control unit 2 may comprise a single simple bridge rectifier and an SCR, the SCR controlling each of the phases of the AC waveform.

A control unit 2 including a semiconductor switching device 21 that comprises a SCR offers yet another advantage and simplification, because the non-controlled (diode-conducted) alternate half-cycle of the AC power supply signal is always “on”, the power supply for the control unit 2 can become part of the zener diode “stack” of the remote units 3, saving cost and circuit complication. Otherwise, each remote unit 3 would require a dedicated constantly available low-voltage DC power supply with its own means of dropping voltage from 120V to 5V for the 60 Hz AC power supply.

Another advantage of example embodiments is that a greater number of LEDs can be supported by the same AC voltage power supply, allowing for a better match of current and voltage. For example, in a conventional constant-on light string of 2 volt LEDs powered by an AC wall power supply, no more than 50 or so LEDs can be wired in series before running out of voltage overhead. In contrast, if each remote unit 3 takes 5 volts, some twenty remote units 3 may be supported, each operating 5 lights, for a total of 100 lights—each one individually controllable in decorative patterns.

However, it is also recognized that various features of example embodiments can be applied to a DC implementation, allowing either battery operation or even simple AC transformer operation of the light string 1. In either battery operation or AC transformer operation of the light string 1, isolating the system from the wall “mains” and operating on low voltage can remove the light string 1 from otherwise applicable safety compliance requirements, thereby allowing for less expensive wires. Alternatively, a low-voltage AC transformer version can work quite similarly to the high-voltage version, allowing for the implementation of a similar but zener-less bridge rectifier in the control unit 2. In a battery implementation, a higher frequency AC waveform can be synthesized and deployed, allowing for a lower value hold-up capacitor 12 in the remote units 3. In either case, a likely complication would be the requirement for more electrical contacts with the remote units 3, which would be wired in parallel rather than in series. As noted above, wire resistance would need to be considered in any low-voltage parallel implementation.

Example embodiments allow for a quadruple use of AC line frequency and voltage of the AC power supply. The transformerless distributed power supply embodied in the zener diode “stack” in the remote units 3 does more than replace the need for a voltage step-down. In an example embodiment comprising local bridge rectifiers in the remote units 3 as shown in FIG. 3A, each remote unit 3 can be configured to operate five LEDs 4 using just three ports of the microcontroller 10. The remote unit 3 itself physically supports its own LED 4 and two single wires are shared each by a pair of LEDs 4 to each side of the remote unit 3. Thus, each wire from each single output port of the microcontroller 10 controls two LEDs 4. This control is accomplished by the use of the AC waveform to implement double use of the same microcontroller ports and their corresponding wires.

In a light string 1 including a remote unit 3 that includes a distributed bridge rectifier 11 as shown in FIG. 3A, the local power lines adjacent but external to the bridge 11 are alternating at 60 Hz between local 0V and local 5V relative to the microcontroller 10 (ignoring for the sake of brevity, a diode drop or two). Two LEDs may be connected to the same port of the microcontroller 10, electrically parallel, but in opposite polarity directions, i.e., an anti-parallel connection, (LEDs conduct and therefore illuminate only in one current direction, as does any well-behaved ordinary diode), each with its other lead to the same local power wire. For example, if LED A is wired in the direction port-to-power-line, then for every other 60 Hz half-wave, LED A sees the port high and the power line low, and will illuminate. The local power line alternates polarity relative to the local DC power supply of the remote unit 3. If the port is low during that same phase, the LED will be dark (zero volts at the port, zero volts on the line). If the local power line goes high, LED A will remain dark regardless of the condition of the port, because it cannot conduct in the reverse direction. Plainly, LED B, wired in parallel with LED A except in opposite polarity, will exhibit the opposite behavior. Moreover, the pair of LEDs on the other side of the remote unit 3 will operate on their own shared microcontroller port and have their own independent control.

It is worth noting that in the arrangement discussed directly above, simply to keep all LEDs dark requires active timed control of the ports. Each LED will illuminate at a 60 Hz multiplexed flash rate with a logical maximum 50% duty cycle, producing sufficient brightness using readily available inexpensive LEDs. However, the actual available maximum duty cycle available is less than 50% because it is preferable to energize the LEDs only when the AC voltage energizes the zener diode stack in the remote units 3. Overdriving the current in the LEDs compensates for any loss in brightness. In fact, almost any AC-operated LED light string illuminates for only part of the AC duty cycle, since the LED operating voltage is achieved only well into the rise of the AC power waveform. The LED that is onboard the remote unit 3 itself, i.e., the LED 4 integrated with the remote unit 3, can operate from a single port and one of the local power lines, or between two ports. If the former, then optimally, a portion of the modules would connect that onboard LED to one side of the local power and the other portion to the other, to balance the overall current. Brightness for each of the LEDs 4 is controlled by means of familiar duty-cycle modulation (often called pulse-width modulation, or PWM) with a maximum of 50% duty cycle as explained above.

Example embodiments can be adapted to display a multiple color effect using a commonly available bi-color LED pair 7 contained within the same LED package in place of one or more of the lights 4, as shown in FIG. 3C. The bi-color LED pair 7 appears identical to a single color LED device, but contains two different color diodes connected “back-to-back” or “anti-parallel”. Thus, one color appears when current flows in one direction and the other color appears in the other current direction. Bi-color LEDs are available in many color pairs and can display variations on multiple colors. For example, a red-green pair can display red, green, and when multiplexed in both directions, yellow. Accordingly, energizing the bi-color LED pair 7 in varying duty cycle degrees in each direction can produce a variety of colors and intensities, delivering another level of entertainment and decoration. Each pair of wing LEDs, which as individual LEDs are already connected back-to-back, is thus reduced to a single bi-color LED 7, and the single color LED on board the remote module is replaced by another bi-color LED 7. Thus, each remote module 3 controls three multi-color lights instead of five single color lights.

Accordingly, the AC waveform from the AC power supply may be employed for at least five purposes in example embodiments. First, it allows for the control of two LEDs with a single wire and microcontroller port. Next, it allows for the efficient implementation of a color version of the light string. As described below, it is also used to keep time in the light shows. Further, it allows for a single wire, namely, the power supply line 5, to convey synchronized control information to the entire light string 1. Finally, because the control signal is integrated into the AC wave form, no separate data line is required and moreover, a problem associated with accommodating differing control signal voltage levels along a series light string may be avoided.

The use of multiple microcontrollers 10, one at each remote unit 3, implements the concepts of distributed intelligence and distributed program. A metaphor of a conductor and a orchestra is useful to help describe example embodiments. The control unit 2 may be thought of as the conductor of an orchestra, the remote units 3 as the musicians and the LEDs 4 themselves as the instruments. The algorithm within each remote microcontroller 10 in each remote unit 3 represents the skills of the musicians at following the conductor's instructions and reading and playing the instruments. The lighting “show” or sequence data within each microprocessor 10 represents the sheet music. Each remote unit 3 already possesses its sheet music; it “knows” its routine already for each “light show” or composition (there can be many shows with different sequences and effects). The control unit 2 (conductor) merely informs the remote units 3 (musicians) which show (piece) to perform, when to start, and conveys a beat to keep time so that everyone does what orchestras are, in the end, supposed to do: begin together and end together. For example, the beat is maintained by the AC line frequency itself, the shape of which the control unit 2 manipulates in order to convey information and instructions to the remote units 3 as to which show to perform and when to start.

Accordingly, a microcontroller 30 in the control unit 2 serving a control box function may be extremely simple, requiring a very short program and very little I/O. However, the control unit 2 is not necessarily required, and a light string according to an example embodiment may include remote units 3 that initialize and synchronize upon receiving the AC waveform. For example, the microcontrollers 10 of each of the remote units 3 may be configured to initiate execution of the one or more programs stored therein to individually control the plurality of lights in response to remote units 3 receiving the AC waveform via the power supply line, e.g., upon power up. The microcontroller 30 sends information including a show number, i.e., a program number indicating a program of the one or more programs stored on the remote units 3 for controlling the lights 4, and start instructions to the remotes, allowing for manual user controls such as a show selection button 31, and preserving and restoring last-show data.

Distribution of algorithm and sequence data is facilitated because of the precipitous decline in recent years of the price of one-chip microcontrollers. At this point, memory and logic circuits are so densely packed and inexpensive that the microcontrollers 10 of the remote units 3 are no more expensive than simple logic gates; in many cases the price of IC packaging outstrips the cost of the IC silicon die itself. However, such chips featuring larger memory space may often only be available including more I/O, leading to disproportionately higher cost. Example embodiments may employ a very low cost sound and speech synthesis IC. The lowest cost versions of these devices feature very little I/O, which suits the present invention perfectly, because one of its aims is to minimize wiring and ports. At the same time, these devices also feature substantial onboard ROM memory because they are designed primarily to deliver voice, music and sounds, which occur in the realm of kilohertz. Adapted for a sequence of lights, even a small amount of sound synthesis memory is relatively vast, because it is played through at a rate no more than 1/100th of the normal speed, a much more efficient use of the same memory. Finally, the processing power required of an algorithm of the remote unit 3 required to receive synchronization instructions and generate light control signals is relatively low.

Various levels of pre-programming routines are possible for the remote units 3. Entire lengthy shows lasting several minutes are one possibility. Alternatively, shorter routines that may be assembled in different order to create more elaborate shows can also be stored, thereby requiring more frequent data transmissions, but also permitting, for example, external composition of shows, perhaps by an external personal computer connected to the light string. Once again, individual addressing of the remote units 3 or the LEDs 4 is not needed; only the global invocation by the control unit 2 of pre-existing routines or programs stored in the remote units 3. Each remote already ‘knows’ its own instructions for each routine or program.

The control unit 2 conveys information to the remote Units 3 via the power supply line 5 through a manipulation of the AC waveform. Because each the remote units 3 already contain their program information, very little data needs to be conveyed to the remote units 3 and moreover, what data that is conveyed can be conveyed quite slowly, by digital standards. In example embodiments just a few bits—a dozen or so—need be transmitted. Each of the remote units 3 interprets the same data and none of that data is directed particularly at any one remote unit 3 or subset of remote units 3. That is, example embodiments do not require any “addressability” in the sense that the control unit 2 addresses instructions to particular remote units 3 or lights 4. Rather, each remote unit 3 (as in an orchestra) refers to its own programs or “sheet music” to perform its own specialized part of the indicated program or show.

To electrically convey a single logical bit of control data or information on the power supply line 5, the AC waveform is manipulated by the control unit 2. A time offset is introduced into one or both of the two phases of the AC waveform. For example, if one phase of the AC power is manipulated, e.g., the phase of the AC power supply signal controlled by the SCR 21 in the control unit 2 as described above, the other phase of the two phases of the AC power supply signal is “constantly on” and never delayed or switched off. Thus, a maximum bit rate of 60 Hz is achieved for a 60 Hz AC power supply signal. This rate is sufficient for sending information from the control unit 2 because the information or control data need be conveyed only when a show begins. Thus, even 30 bits would take just 1/2 second and most of the time, no data is conveyed at all, during which the remote units 3 can be busy servicing the LEDs 4 and simply monitoring for any incoming information or control data. For example, such incoming data might also be a user instruction to switch shows, which could be initiated at any time by the press of a button on the control box. Moreover, if remote processor power is strained in the remote units 3, for practical purposes the microcontrollers 10 do not even need to be servicing the LEDs 4 while receiving occasional data.

The microprocessor 10 in each remote unit 3 detects the phase offset that identifies a logic bit by monitoring the AC waveform on the power supply line 5 and comparing zero-crossings of the AC waveform to detect the information. Each remote unit 3 may include a resistor divider pair 8 (or equivalent means) as shown in FIG. 3c that delivers the local AC state of the AC waveform to an input port of the microcontroller 10. The microcontroller 10 monitors the port, counting a time since a previous zero-crossing of the AC power supply signal, and determines if the onset of the voltage has been delayed, thereby decoding a data bit. Alternatively, the control unit 2 may be configured to send the information via the power supply line to the plurality of remote units 3 by varying an amount of the time offset within the one or both of the two phases of the AC waveform such that each additional discrete amount of time offset represents an additional logical bit.

Another reason for restricting the data rate to a single bit per half-cycle of the AC power supply signal is that the data can only be securely looked for and detected when the entire stack of zener diodes in the remote units 3 is under full voltage. This occurs at some point well after the zero-crossing of the AC waveform, thus narrowing the window for locating such a time offset of the AC waveform. Not only does the light string 1 according to example embodiments require no greater speed than this method allows, but it is simpler programming-wise and more robust, even permitting the remote units 3 to tolerate variations in line frequency, voltage and zener diode characteristics. Thus, with respect to data, no setting or special provision need be made to accommodate a light string 1 running instead on a 50 Hz AC power supply signal.

Each remote unit 3 includes a hold-up capacitor 12. The hold-up capacitor 12 is configured to preserve operating power, i.e., the local DC power, to the microprocessor 10 during the time in between AC voltage peaks, when the zener diode stack becomes de-energized. Because a full-wave bridge rectifier may be employed in the remote units 3 as shown in FIG. 3A, full-wave power is delivered to each microprocessor 10 and, therefore, the required hold-up time for the capacitor 12 is well under a half-cycle. But, because the non-controlled AC phase is always on, power must disappear and the microcontroller 10 reset sequence occur fast enough to take safely less than a single ½ cycle of the AC waveform (approximately 8.3 ms at 60 Hz).

A capacitance of the hold-up capacitor 12 should be minimized for reasons of both cost and physical size. Yet another reason for narrowing the time window of data phase delay is to minimize the value of the hold-up capacitor 12, which must maintain microcontroller operating voltage during the absence of power. For example, if a SCR in the control unit 2 remains OFF and not conveying any power at all, the hold-up capacitors 12 in each of the remote units 3 may drain low enough for all microcontrollers 10 to power down and then, upon the return of voltage in the next half-cycle, to power up in a reset state.

The LEDs 4 are the main users of current in the light string 1, so another part of a strategy to minimize the capacitance of the hold-up capacitors 12 is to switch off the LEDs 4 when the zener diode stack in the remote units 3 is not energized, thereby not draining the hold-up capacitor 12 for illumination. The use of a microcontroller with very low operating current for the microcontrollers 10 also helps to minimize the capacitance of the hold-up capacitor 12. A microcontroller with a quiescent or “sleep” mode from which the microcontroller 12 can recover quickly is also useful for minimizing the capacitance of the hold-up capacitor 12.

The control unit 2 may, from time to time or periodically, create a reset event in order to maintain proper system order, in case any of the microcontrollers 10 in the remote units 3 has gone “insane” for any reason—e.g., a transient electrical event or a mistake of data or timing. The reset event, similar to a familiar watchdog function, may occur as a very brief dark period between shows and be trigged by the control unit 2 sending information to the remote units 3 indicating the reset event. Upon power-up of the light string 1, information including a data sequence is sent to the remote units 3 from the control unit 2 to dictate which light show or program is then to commence.

In an example embodiment, the control unit 2 includes a memory or storage, for example in the microcontroller 30, for preserving the last show or program selected before power-down, so that when the light string 1 is later powered up again, information indicating the last selected show is sent to the remote units 3 and the last selected show displays. Various means are available to achieve this end, including a battery backup or high-value capacitor (e.g., a supercap) to hold up control memory in the control unit 2 in a sleep mode or non-volatile memory, either onboard or outboard of the control IC. Once again, as with the watchdog feature described above, upon power-up, the control unit sends information including a data sequence to the newly reset remote units 3 to indicate the number of the user's last selected show.

Between the occasional transmissions of show selection data from the control unit 2 to the remote units 3, the AC waveform itself is employed as a common time base so that all remote modules keep in synchronization and they begin their shows together and end their shows together.

Other information and data conveyance methods can be employed in example embodiments, including, as described above, a data conveyance method that allows for varying amounts of delay within a single half-cycle, each discrete amount of phase delay representing more than one logical bit. Another variation would be to impose data on each of the two half-cycles of the AC waveform through the use of a TRIAC instead of an SCR. Still another variation would be the use of a bi-polar transistor or MOSFET instead of an SCR to manipulate the AC waveform, e.g., to switch the AC waveform at a higher frequency, which allows for a smaller hold-up capacitor 12 in the remote units 3.

In many decorative light strings and related products, a desirable feature is the inclusion of an “end-connect” feature, involving power outlet 9, e.g., a remote AC female outlet usually situated at the far end of the light string 1 from the male AC plug. End-connect simplifies holiday decorative lighting setup by avoiding the need for running extension cords, allowing the light string itself to serve as an extension cord. In order to succeed as a true end-connect system, two requirements must be met. First, real standard AC power must be delivered to the remote outlet 9 and second, the power handling ability of the remote outlet 9 must be sufficient. In example embodiments, both conditions are easily met and, in fact, at least two more valuable user features related to synchronization and coordination are enabled.

Because the information or data sequence is sent only occasionally (on the order of once every many seconds) from the control unit 2, and the SCR control in the control unit 2 represents only a small compromise of the AC power waveform, the power outlet 9 conveys true AC for the practical purposes of stringing even conventional lighting products onto the end of the specialized light string 1. The power-handling capacity of the end-connect power outlet 9 depends upon the specification of the SCR and its parallel half-cycle diode, both of which can be inexpensively over-specified to a rating adequate for a practical and UL-approvable number of additional light strings.

A control unit of another light string according to an example embodiment added through an end connect feature according to an example embodiment can also examine the incoming AC waveform at the power outlet 9 in order to determine if it is itself connected to the end-connect socket of a light string of its own type. If so, at least two additional features are enabled. First, show-selection control can be accepted by the additional light string (and further ones as well), allowing the user select button on the first control unit 2 to control each downstream light string, e.g., creating a master-slave configuration between the control units of the light strings. This may be called synchronization, so that the same shows are begun together and end together under synchronized control. Beyond that, though, lies what may be called “coordination”, wherein each succeeding light string self-identifies as to which one it is along the string, and then coordinates its behavior so that it is not merely duplicating the shows of the earlier strings, but displaying its own part of a more comprehensive overall show. In order to accomplish such self-identification, the information or data stream must also be modified by each control unit in each light stream, essentially incrementing the string identification for the next light string to detect.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed:

1. A light string, comprising:
a plurality of remote units, each of the plurality of remote units comprising a microcontroller and being connected to a plurality of lights, wherein each microcontroller is configured to store one or more programs for controlling the lights in the plurality of lights; and
a control unit connected to the plurality of remote units by a power supply line, the control unit configured to send information via the power supply line to the plurality of remote units, the information indicating a program of the one or more programs to be executed by the microcontroller of each of the remote units to individually control the plurality of lights.

2. The light string according to claim 1, wherein each microcontroller is connected to a different plurality of lights, and the one or more programs stored by each microcontroller is for individually controlling the different plurality of lights.

3. The light string according to claim 2, wherein at least one light of the different plurality of lights connected to each of the remote units is integrated with the remote unit, and each of the remainder of the different plurality of lights connected to each of the remote units is external to the remote unit and connected to the remote unit by at least one LED control line.

4. The light string according to claim 1, wherein the plurality of remote units are in electrical series on the power supply line.

5. The light string according to claim 4, wherein the power supply line is configured to provide an AC waveform.

6. The light string according to claim 5, wherein each of the remote units comprise a hold-up capacitor and an asymmetrical bridge rectifier including first and second zener diodes and first and second other diodes, the asymmetrical bridge rectifier and the hold-up capacitor being configured to produce from the AC waveform a local DC power supply to the microcontroller.

7. The light string according to claim 5, wherein each of the remote units comprises a single zener diode, a single isolation diode and a hold-up capacitor, the single zener diode, the single isolation diode and the hold-up capacitor being configured to produce from the AC waveform a local DC power supply to the microcontroller.

8. The light string according to claim 7, wherein a portion of the remote units of the plurality of remote units have the single zener diode oriented in one current direction of the power supply line, and the other portion of the remote units of the plurality of remote units have the single zener diode oriented in the other current direction of the power supply line.

9. The light string according to claim 5, wherein the microcontroller of at least one remote unit of the plurality of remote units is configured to control two lights of the plurality of lights from a single output port, the two lights being connected to the single output port in electrical parallel and in opposite polarity directions.

10. The light string according to claim 5, wherein the microcontroller of at least one remote unit of the plurality of remote units is configured to control a single light of the plurality of lights with a single output port, wherein the single light is a bi-color LED pair including first and second color diodes connected in parallel and in opposite polarity directions.

11. The light string according to claim 1, wherein the one or more programs stored by the microcontroller of each remote unit is a plurality of programs.

12. The light string according to claim 11, wherein the microcontrollers of the plurality of remote units are divided into a plurality of different groups, the microcontrollers of each of the plurality of different groups storing a different plurality of programs for controlling the lights in the plurality of lights.

13. The light string according to claim 5, wherein the control unit comprises a semiconductor switching device configured to control one or both of the two phases of the AC waveform on the power supply line.

14. The light string according to claim 13, wherein the semiconductor switching device comprises a silicon controlled rectifier (SCR) configured to control one of the two phases of the AC waveform on the power supply line, and the control unit further comprises a diode configured to conduct current on the other of the two phases of the AC waveform on the power supply line.

15. The light string according to claim 13, wherein the semiconductor switching device comprises a single bridge rectifier and a silicon controlled rectifier (SCR) configured to control each of the two phases of the AC waveform on the power supply line.

16. The light string according to claim 13, wherein the semiconductor switching device comprises a triode for alternating current (TRIAC) configured to control each of the two phases of the AC waveform on the power supply line.

17. The light string according to claim 1, wherein the power supply line is configured to provide a DC waveform, and the plurality of remote units are in electrical parallel on the power supply line.

18. The light string according to claim 5, wherein the control unit is configured to send the information via the power supply line to the plurality of remote units by manipulating the AC waveform.

19. The light string according to claim 18, wherein the control unit is configured to send the information via the power supply line to the plurality of remote units by introducing a time offset into one or both of the two phases of the AC waveform.

20. The light string according to claim 19, wherein the control unit is configured to send the information via the power supply line to the plurality of remote units by varying an amount of the time offset within the one or both of the two phases of the AC waveform such that each additional discrete amount of time offset represents an additional logical bit.

21. The light string according to claim 18, wherein each of the remote units is configured to compare zero-crossings of the AC waveform to detect the information.

22. The light string according to claim 18, wherein the information further indicates a start time for beginning execution of the indicated program, and wherein a frequency of the AC waveform indicates a synchronization signal to the plurality of remote modules.

22. The light string according to claim 1, wherein the control unit is configured to store in a non-volatile memory the information indicating the program last sent to the plurality of remote modules.

23. The light string according to claim 5, further comprising a power outlet connected to the power supply line, the power outlet configured to provide the AC waveform to another light string,
wherein a control unit of the other light string is configured to monitor the AC waveform and control another plurality of remote units based on the information.

24. A light string, comprising:
a plurality of remote units, with each comprising a microcontroller and being connected to a plurality of lights, wherein each microcontroller is configured to store one or more programs for controlling the lights in the plurality of lights; and
a power supply line configured to provide an AC waveform to the plurality of remote units, wherein the microcontrollers of each of the remote units are configured to initiate execution of the one or more programs to individually control the plurality of lights in response to the plurality of remote units receiving the AC waveform via the power supply line.

25. A light string, comprising:
a plurality of remote units, each comprising a microcontroller and being connected to a different single light, wherein each microcontroller is configured to store one or more programs for controlling the single light, and wherein the single light is integrated with the remote unit; and
a control unit connected to the plurality of remote units by a power supply line, the control unit configured to send information via the power supply line to the plurality of remote units, the information indicating a program of the one or more programs to be executed by the microcontroller of each of the remote units to control the single light.
